(19) United States
(12) Patent Application Publication
(10) Pub. No.: US 2011/0145311 A1
(43) Pub. Date: Jun. 16, 2011

(54) METHOD AND APPARATUS FOR MODULO N OPERATION

(75) Inventors: Eun-Sook JIN, Daejeon-si (KR); Il-Gyu Kim, Okcheon-gun (KR); Hyun-Kyu Chuno, Daejeon-si (KR)

(73) Assignee: Electronics and Telecommunications Research Institute, Daejeon (KR)

(21) Appl. No.: 12/967,712

(22) Filed: Dec. 14, 2010

(30) Foreign Application Priority Data
Dec. 16, 2009 (KR) 10-2009-0125665
Jul. 2, 2010 (KR) 10-2010-0063896

(51) Int. Cl. G06F 7/38

(52) U.S. Cl. 708/491

(57) ABSTRACT

A method and apparatus for a modulo N operation are provided. The method for a modulo N operation on a positive integer X includes converting the positive integer X into a binary number, determining whether a modulo N is expressed by a product of 2 to the m^{th} power and a value obtained by adding or subtracting one to or from 2 to the n^{th} power, calculating the positive integers m and n, if the modulo N is expressed by the product of 2 to the m^{th} power and the value obtained by adding or subtracting one to or from 2 to the n^{th} power, and grouping the binary number of the positive integer X into bit units varying according to the positive integers m and n to perform operation on the binary number of the positive integer X. Accordingly, it is possible to reduce complexity of a modulo operation using a simple adder and logic circuit.

### CROSS REFERENCE TO RELATED APPLICATION(S)

This application claims the benefit under 35 U.S.C. §119(a) of a Korean Patent Application Nos. 10-2009-0125665, filed on Dec. 16, 2009, and 10-2010-0063896, filed on Jul. 2, 2010, in the Korean Intellectual Property Office, the entire disclosures of which are incorporated herein by references for all purposes.

### BACKGROUND

1. Field

The following description relates to a modulo N operation, and more particularly, to a method and apparatus for a modulo N operation.

2. Description of the Related Art

Third generation partnership project long term evolution (3GPP LTE) is advanced technology of wideband code division multiple access (WCDMA), which is 3G mobile communication technology, and one of candidate technologies for fourth generation (4G; international mobile telecommunication (IMT)-Advanced) mobile communication. 3GPP LTE is based on a cellular system among conventional mobile communication systems, and is similar to 4G mobile communication which will enable multimedia service during high-speed movement. Due to service during high-speed movement, 3GPP LTE is remarkably distinguished from wireless broadband (WiBro), which is a conventional medium or low-speed mobile service, or 4G new nomadic local area wireless access (NoLA), which is 3 Gbps wireless transmission technology.

Such 3GPP LTE technology also enables global roaming which supports interoperation with a global system for mobile communications (GSM) or WCDMA network as well as a conventional second generation (2G) cellular network. Operation schemes such as modulo 3, modulo 6, modulo 12, modulo 30, modulo 31, and modulo 65537 are essentially used in the 3GPP LTE standard. Thus, the following techniques have been proposed for efficient modulo operation.

In a conventional modulo 3 operation using a counter, while a first counter counts from 1 to an input integer N one by one, a second counter counts the numbers in order of 0, 1, 2, 0, 1, 2, . . . . When the first counter finishes counting from 1 to the input integer N, a value of the second counter is checked and output as a result value. In such a modulo operation apparatus, both of the two counters should count as many numbers as the integer, and thus much operation time is required with an increase in the input integer N.

As another conventional technique, there is a modulo 3 operation using a counter and an AND operation. In the modulo 3 operation, an AND operation is performed on four bits of an input binary number and a specific binary number two times to determine an operation result, and an output register value is added according to the operation result. Such an operation can more rapidly calculate a result value than the modulo operation using a counter. However, it may be necessary to modify a structure according to an input value, and the operation is complicated because at least one counter is used.

### SUMMARY

The following description relates to a modulo operation technique which has complexity reduced by a modulo operation without a counter, rapidly calculates a result value of the operation, and enables an operation circuit to be easily extended according to an input value.

In an exemplary embodiment of the present invention, there is provided a method for a modulo N operation on a positive integer X is as follows. The positive integer X is converted into a binary number. It is determined whether a modulo N is equal to a product of 2 to the m^{th} power and a value obtained by adding or subtracting one to or from 2 to the n^{th} power, and the positive integers m and n are calculated, if the modulo N is equal to the product of 2 to the m^{th} power and the value obtained by adding or subtracting one to or from 2 to the n^{th} power. The binary number of the positive integer X is grouped into bit units varying according to the positive integers m and n to perform operation on the binary number of the positive integer X. All bits of the binary number of the positive integer X consist of r (r is a positive integer) n-bit units and m least significant bits.

The performing of the operation on the binary number of the positive integer X includes calculating a value of a modified n-bit unit obtained by adding an upper bit to each of the n-bit units, calculating final n bits from the value of the modified n-bit unit using a multiplexer and an adder, and adding the m least significant bits to the final n bits to generate a binary modulo operation value.

The calculating of the final n bits includes outputting the value of the modified n-bit unit as a first bit unit value when the value of the modified n-bit unit is smaller than a value obtained by adding or subtracting one to or from 2 to the n^{th} power, and subtracting the value obtained by adding or subtracting one to or from 2 to the n^{th} power from the value of the modified n-bit unit and outputting the result value as the first bit unit value when the value of the modified n-bit unit is larger than the value obtained by adding or subtracting one to or from 2 to the n^{th} power, and when the first bit unit is plural in number, adding the output first bit unit values to calculate a second bit unit. The calculating of the final n bits includes repeating the calculating of the final n bits until the second bit unit corresponds to the final n bits.

In an exemplary embodiment of the present invention, there is provided an apparatus for a modulo N operation. The apparatus for a modulo N operation includes a binary number converter configured to convert a positive integer X into a binary number, a variable calculator configured to determine whether a modulo N is equal to a product of 2 to the m^{th} power and a value obtained by adding or subtracting one to or from 2 to the n^{th} power and calculate the positive integers m and n, if the modulo N is equal to the product of 2 to the m^{th} power and the value obtained by adding or subtracting one to or from 2 to the n^{th} power, and a bit unit calculator configured to perform operation on the binary number of the positive integer X according to bit units varying according to the positive integers m and n.

The bit unit calculator includes a modified n-bit unit calculator configured to calculate a value of a modified n-bit unit obtained by adding an upper bit to each of the n-bit units, a final n-bit calculator configured to calculate final n bits from the value of the modified n-bit unit using a multiplexer and an adder, and a bit combiner configured to add the m least significant bits to the final n bits calculated by the final n-bit calculator.

The final n-bit calculator includes a first bit unit calculator configured to output the value of the modified n-bit unit as a first bit unit value when the value of the modified n-bit unit is smaller than a value obtained by adding or subtracting one to or from 2 to the n^{th} power, and subtract the value obtained by adding or subtracting one to or from 2 to the n^{th} power from the value of the modified n-bit unit and output the result value as the first bit unit value when the value of the modified n-bit unit is larger than the value obtained by adding or subtracting one to or from 2 to the n^{th} power, and a second bit unit calculator configured to add, when the first bit unit is plural in number, the output first bit unit values to calculate a second bit unit. The bit combiner repeats the calculation until the second bit unit corresponds to the final n bits.

Accordingly, a modulo operation can be performed using only an adder and a logic circuit. Thus, it is possible to simply construct hardware and improve the modulo operation speed.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a flowchart of a method for a modulo N operation according to an exemplary embodiment of the present invention.

FIG. 2 illustrates an example in which a binary number is grouped into bit units according to a method for a modulo N operation according to an exemplary embodiment of the present invention.

FIG. 3A illustrates an example of a modulo 6 operation according to an exemplary embodiment of the present invention.

FIG. 3B illustrates an example of a modulo 10 operation according to an exemplary embodiment of the present invention.

FIG. 4 is a block diagram of an apparatus for a modulo N operation according to an exemplary embodiment of the present invention.

FIG. 5 is a block diagram of a first bit unit calculator in an apparatus for a modulo N operation according to an exemplary embodiment of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

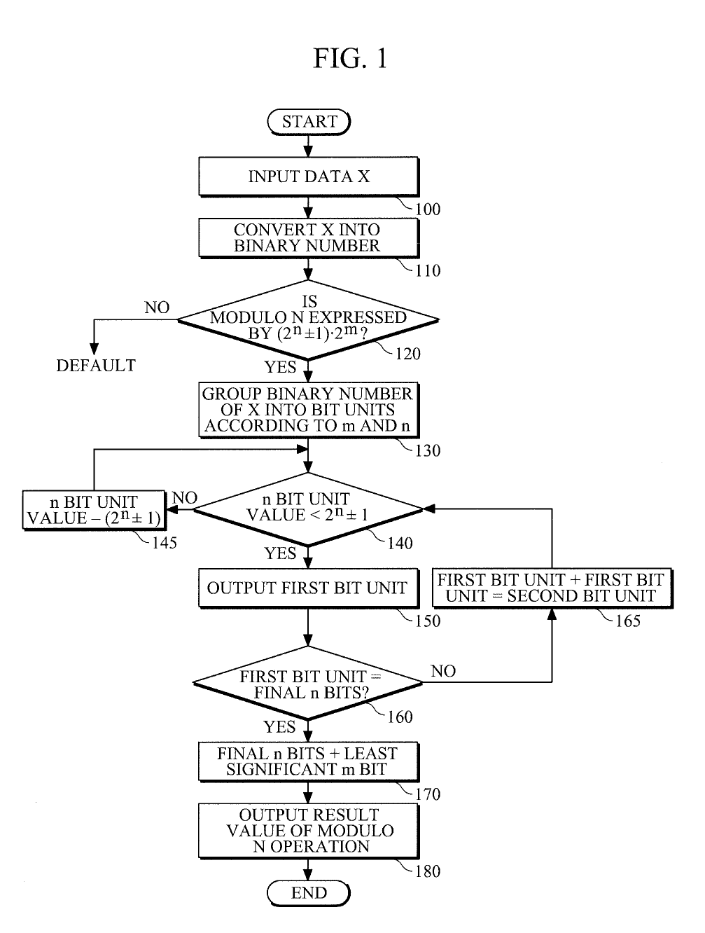

FIG. 1 is a flowchart of a method for a modulo N operation according to an exemplary embodiment of the present invention.

Referring to FIG. 1, first, data X on which a modulo N operation will be performed is input (operation 100). The input data X is a positive integer. The input data X is converted into a binary number (operation 110). In a modulo operation using a computer, binary numbers can be used. After that, it is determined whether a modulo N satisfies a predetermined equation (operation 120). In this operation, the modulus N to which a method proposed by an exemplary embodiment of the present invention can be applied is determined.

N=(2ⁿ±1)·2^{m} [Equation 1]

In Equation 1, N is a positive integer, and n and m are also positive integers. In a modulo operation method according to an exemplary embodiment of the present invention, N should be expressed by Equation 1. Such a value of N may include 3, 6, 12, 30, 31 and 65537 with which most modulo operations required in the third generation partnership project long term evolution (3GPP LTE) standard are performed. Accordingly, it is determined whether the value of N is expressed by Equation 1, and if the value of N is not expressed by Equation 1, a default is output.

Subsequently, if positive integer N is expressed by equation 1, positive integers m and n are calculated, and the binary number of X is grouped into bit units using the calculated m and n (operation 130).

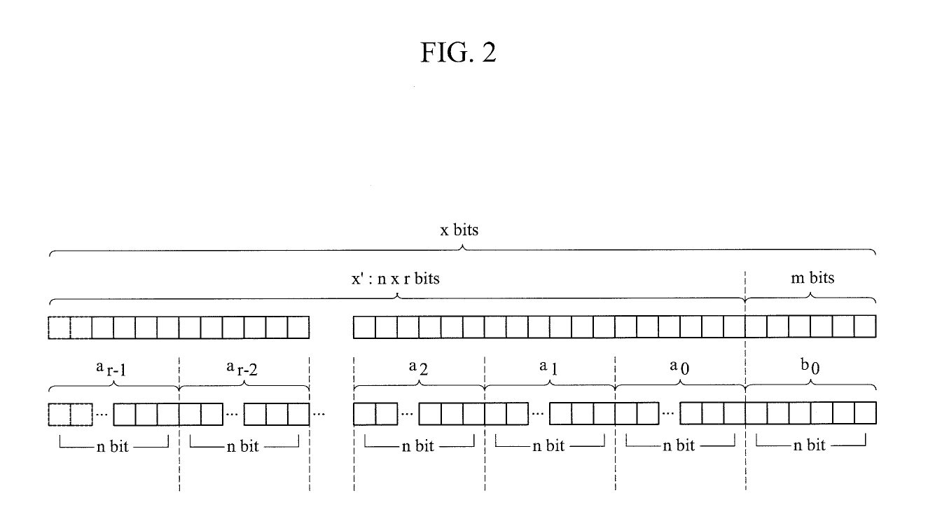

Each of n and m satisfying Equation 1 is the number of bits, and used to group bits of a binary number of X. m denotes the number of least significant bits of the binary number of X, and n denotes the number of bits of each bit unit whereby bits other than the least significant bits are grouped. For example, in a modulo 6 operation, six can be expressed as 6=(2²±1)·2¹, m=1, and n=2. A decimal number 435 is expressed as a binary number 110110011₂. Since m is 1, the number of least significant bits is 1. Also, since n is 2, bits other than the least significant bit are paired. The grouping of the binary number of X into bit units will be described later with reference to FIG. 2.

FIG. 2 illustrates an example in which the binary number of X is grouped into bit units according to a method for a modulo N operation according to an exemplary embodiment of the present invention. Referring to FIG. 2, the number of entire bits of X converted into the binary number can be expressed by the sum of X′ bits and m bits. The X′ bits can be grouped into several n-bit units.

n×(r−1)<X′≦n×r [Equation 2]

Referring to Equation 2, r denotes the number of the n-bit units into which the X′ bits are grouped. According to Equation 2, X′ may be larger than a product of n and a number smaller than r by 1, and equal to or smaller than a product of n and r. For example, when a modulo 6 operation is performed on the decimal number 435, n=2, m=1, and X converted into a 9-bit binary number consists of four n-bit units and one least significant bit.

In FIG. 2, a denotes a value of each n-bit unit. This is expressed by the following equation.

$$\begin{matrix}X = \{ \begin{matrix}{{a}_{r - 1} ( {2}^{n} )}^{r - 1} + {{a}_{r - 2} ( {2}^{n} )}^{r - 2} + … + \\ {{a}_{2} ( {2}^{n} )}^{2} + {{a}_{1} ( {2}^{n} )}^{1} + {{a}_{0} ( {2}^{n} )}^{0}\end{matrix} \} \cdot \\ {2}^{m} + {b}_{0} \\ = {X}^{′} \cdot {2}^{m} + {b}_{0}\end{matrix} \qquad [ Equation 3 ]$$

Referring to Equation 3, the positive integer X is equal to a value obtained by adding b₀ to a product of X′ and 2 to the m^{th} power. In other words, the positive integer X is equal to a result of a modulo 2 operation on X. In the modulo 2 operation, a remainder of dividing the positive integer X by two is calculated, and thus the result value of the modulo 2 operation in Equation 3 is b₀. Meanwhile, a modulo 6 operation is equal to multiplication of a modulo 2 operation and a modulo 3 operation. Thus, the positive integer X is expressed as shown in Equation 3, so that the modulo 6 operation can be efficiently denoted as the sum of b₀ and the result value of the modulo 3 operation on X′.

Referring back to FIG. 1, it is determined whether or not each of values of the r n-bit units is smaller than (2ⁿ±1) (operation 140). Modulus N=(2ⁿ±1)·2^{m}) may be considered a repeated modulo operation with a modulus (2ⁿ±1) and another modulus 2′. In Equation 3, X′ is the same as a result of a modulo 2 operation on X. Thus, only a modulo (2ⁿ±1) operation needs to be performed on X′. For this reason, it is determined whether or not each of values of the r n-bit units is smaller than (2ⁿ±1), thereby performing a modulo (2ⁿ±1) operation.

A first bit unit denotes an n-bit unit having a value from which no quotient is generated by a modulo operation. When the value of an n-bit unit is larger than (2ⁿ±1), a quotient is generated. Thus, (2ⁿ±1) is subtracted from the value (operation 145). It is determined again whether or not the result value is smaller than (2ⁿ±1). When the result value is smaller than (2ⁿ±1), the result value is output as the first bit unit. When the value of the n-bit unit is smaller than (2ⁿ±1), a modulo (2ⁿ±1) operation is no longer performed, and the n-bit unit is output as the first bit unit (operation 150).

$$\begin{matrix}{X}^{′} = {a}_{r - 1} {\{ ( {2}^{n} - 1 ) + 1 \}}^{r - 1} + \\ {a}_{r - 2} {\{ ( {2}^{n} - 1 ) + 1 \}}^{r - 2} + … + \\ {a}_{2} {\{ ( {2}^{n} - 1 ) + 1 \}}^{2} {b}_{0} + \\ {a}_{1} {\{ ( {2}^{n} - 1 ) + 1 \}}^{1} + {a}_{0} \\ = {( {a}_{r - 1} + {a}_{r - 2} + … + {a}_{2} + {a}_{1} + {a}_{0} )}_{modulo ( {2}^{n} - 1 )}\end{matrix} \qquad [ Equation 4 ]$$

Referring to Equation 4, a denotes a value of each n-bit unit. When a modulo (2″-1) operation is performed on a, the first bit unit is generated. The first bit unit has one or two more bits than the n-bit unit. This takes into consideration an overflow generated by addition of first bit units to be described later and a sign bit added for calculating a negative number.

Referring back to FIG. 1, after a first bit unit is output, it is determined whether or not the first bit unit corresponds to final n bits (operation 160). The final n bits denote an n-bit unit finally obtained from X. The X′ bits are grouped into the r n-bit units at first, but finally, the respective n-bit units are integrated to generate one n-bit unit.

When the first bit unit does not correspond to the final n bits, adjacent two first bit units of all first bit units are added to each other (operation 165). Thus, the number of the n-bit units is reduced to half, and the value of the n-bit units increases. The generated bit unit is set as a second bit unit, and the operation of determining whether or not the value of a second bit unit is smaller than (2ⁿ±1) and the operation of determining whether or not the second bit unit corresponds to final bits are repeated (operations 140, 150 and 160).

When the first bit unit corresponds to the final n bits, the final n bits are combined with the m least significant bits (operation 170). Since the least significant bits are determined first, the least significant bits of the final n bits are not the least significant bits of X converted into a binary number. The m least significant bits are combined with the final n bits, and the result is output as a modulo operation value (operation 180).

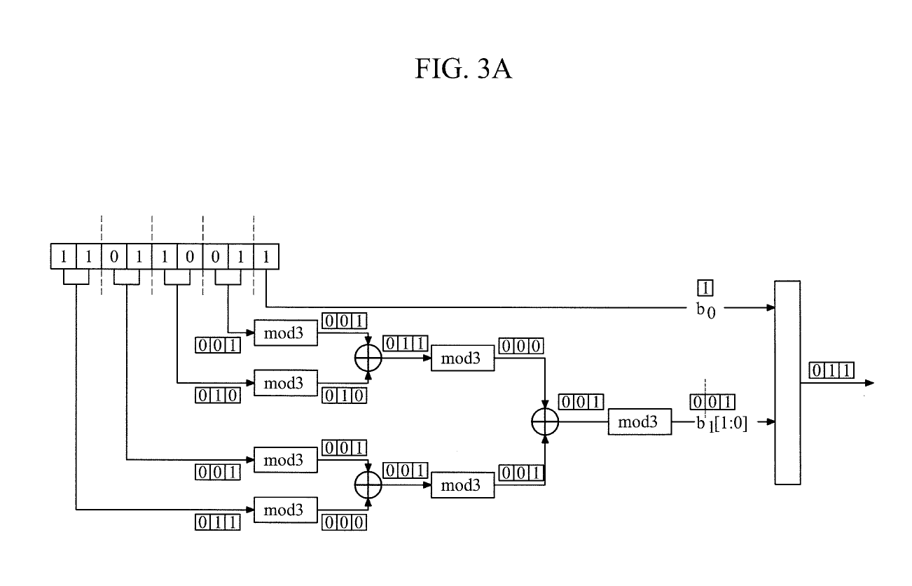

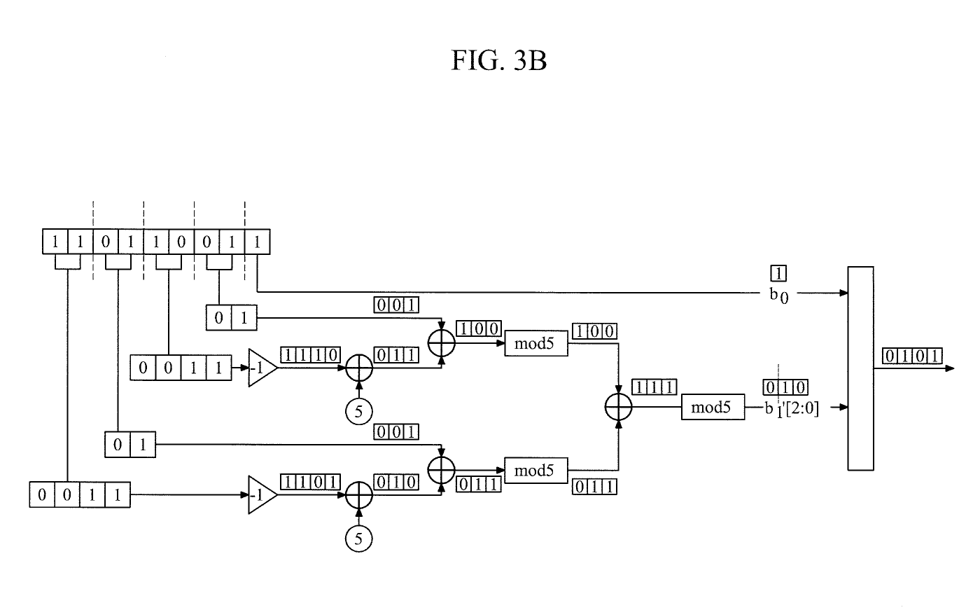

FIG. 3A illustrates an example of a modulo 6 operation according to an exemplary embodiment of the present invention.

Referring to FIG. 3A, an input X is 435, which is expressed as a binary number 110110011₂. Since a modulus is 6, m=1, and n=2. Thus, the number of least significant bits is one, and the other eight bits can be grouped into four 2-bit units. The value of each of 2-bit units is the same as that obtained through a modulo 2 operation. One bit is added to each of the 2-bit units so that the 2-bit units become three bit units. The added bit is an additional bit prepared for an overflow.

Subsequently, a modulo 3 operation is performed on each three bit units, which correspond to modified n bit units, to generate a first bit unit. When the first bit unit does not correspond to final two bits, the first bit unit is added to another first bit unit, and a modulo 3 operation is performed again on the result to generate a second bit unit. Through this process, final two bits become 01. Since the least significant bit value is 1, a modulo 6 operation value is 011, which is a decimal number 3. In other words, it is possible to obtain 3 as the modulo 6 operation value using three adders.

FIG. 3B illustrates an example of a modulo 10 operation according to an exemplary embodiment of the present invention.

Referring to FIG. 3B, an input X is 435, which is expressed as a binary number 110110011₂. Since a modulus is 10, m=1, and n=2. Thus, the number of least significant bits is one, and the other eight bits can be grouped into four 2-bit units. The value of each of 2-bit units is the same as that obtained through a modulo 2 operation. One bit is added to each of the 2-bit units so that the 2-bit units have three bits. The added bit is an additional bit prepared for an overflow. Also, a sign bit may be added to some bit units so that the bit units have four bits.

$$\begin{matrix}{X}^{′} = {a}_{r - 1} {\{ ( {2}^{n} + 1 ) - 1 \}}^{r - 1} + \\ {a}_{r - 2} {\{ ( {2}^{n} + 1 ) - 1 \}}^{r - 2} + … + \\ {a}_{2} {\{ ( {2}^{n} + 1 ) - 1 \}}^{2} + \\ {a}_{1} {\{ ( {2}^{n} + 1 ) - 1 \}}^{1} + {a}_{0} \\ = {\{ \begin{matrix}{( - 1 )}^{r - 1} \cdot {a}_{r - 1} + {( - 1 )}^{r - 2} \cdot \\ {a}_{r - 2} + … + \\ {a}_{2} \_ {a}_{1} + {a}_{0}\end{matrix} \}}_{modulo ( {2}^{n} + 1 )}\end{matrix} \qquad [ Equation 5 ]$$

Referring to Equation 5, (2²+1) is included in X′ in this modulo 10 operation. This means that the value of a specific bit can be expressed by a negative number. Thus, a specific bit unit having a negative sign requires a negative sign bit. The value of a specific bit unit having a negative sign is calculated using the complement of two. For example, the bit unit of ‘10’ shown in FIG. 3B corresponds to −2 in a binary number. The complement of two is calculated in a binary number system, and five is added to the complement of two, thereby generating a first bit unit having a value of 3.

Subsequently, like in FIG. 3A, three bits are finally generated using first bit units. Since the generated final three bits are 010 and the value of the least significant bit is 1, the result value of the modulo 10 operation is 0101. This is a decimal number 5, which is a remainder obtained by dividing 435 by 10.

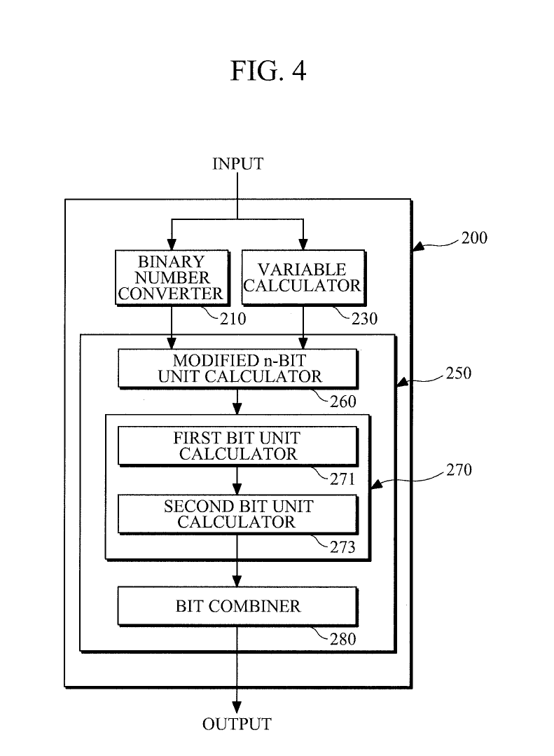

FIG. 4 is a block diagram of an apparatus for a modulo N operation according to an exemplary embodiment of the present invention.

Referring to FIG. 4, a binary number converter 210 converts a positive integer X into a binary number. The binary number converter 210 can be implemented by a logic circuit generally used for converting a decimal number into a binary number. A variable calculator 230 determines whether a modulo N is equal to a product of 2 to the m^{th} power and a value obtained by adding or subtracting one to or from 2 to the n^{th} power and calculates the positive integers m and n, if the modulo N is equal to the product of 2 to the m^{th} power and the value obtained by adding or subtracting one to or from 2 to the n^{th} power. A binary number operation unit 250 performs operation on the binary number of X converted by the binary number converter 210 according to bit units varying according to m and n calculated by the variable calculator 230.

The binary number operation unit 250 includes a modified n-bit unit calculator 260 which adds an upper bit to n-bit units, a final n-bit calculator 270 which performs calculation to leave only one n-bit unit, and a bit combiner 280 which adds m bits to final n bits as least significant bits to generate a binary modulo operation value. The modified n-bit unit calculator 260 receives binary data of X from the binary number converter 210 and the variables m and n whereby the binary data of X will be grouped from the variable calculator 230. The modified n-bit unit calculator 260 groups bits of the binary data of X other than a least significant bit into an n-bit unit, adds an upper bit to the n-bit unit, and outputs the modified n-bit unit to the final n-bit calculator 270.

The final n-bit calculator 270 may include a first bit unit calculator 271 and a second bit unit calculator 273. The first bit unit calculator 271 receives the modified n-bit unit from the modified n-bit unit calculator 260, and generates a result of performing a modulo operation on the modified n-bit unit. The generated first bit unit is output to the second bit unit calculator 273. The second bit unit calculator 273 determines whether or not the first bit unit corresponds to final n bits. When the first bit unit corresponds to the final n bits, the first bit unit is output to the bit combiner 280. On the other hand, when the first bit unit does not correspond to the final n bits, the second bit unit calculator 273 adds adjacent two first bit units of all first bit units to each other, thereby generating a second bit unit.

The bit combiner 280 receives the final n bits from the final n bit calculator 280 and combines the final n bits with a least significant bit. The bits generated by the bit combiner 280 correspond to the result value of the modulo N operation on X.

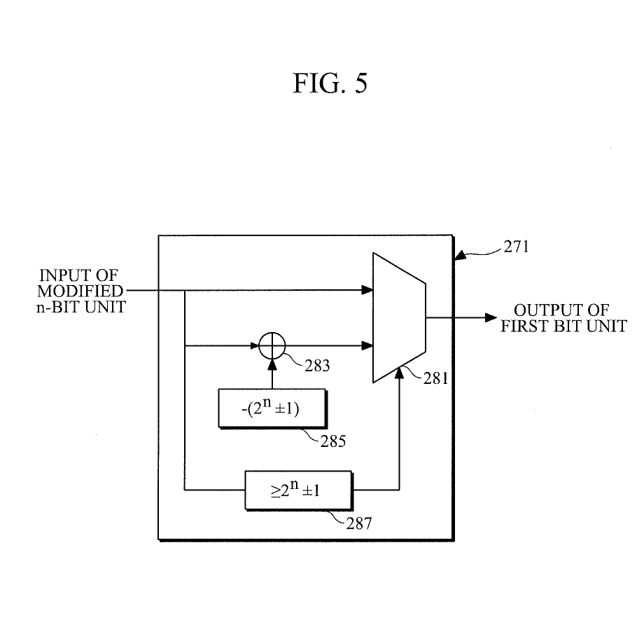

FIG. 5 is a block diagram of the first bit unit calculator 271 in the apparatus for a modulo N operation according to an exemplary embodiment of the present invention.

Referring to FIG. 5, the first bit unit calculator 271 may include a multiplexer 281 and an adder 283. The multiplexer 281 receives a modified n-bit unit value, and outputs the value as a first bit unit when the value is smaller than a comparison value 287. When the modified n-bit unit value is larger than the comparison value 287, a set addition value 285 is subtracted from the modified n-bit unit value. Thus, the first bit unit calculator 271 outputs a value smaller than the comparison value 287.

An apparatus for a modulo N operation according to an exemplary embodiment of the present invention can perform a modulo N operation on a positive integer using only the multiplexer 281 and the adder 283 without a counter when the number of input bits is determined. The number of the adders 283 varies according to a number r of n bit units. Since the apparatus has simple hardware, it is possible to improve the modulo operation speed.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method for a modulo N operation on a positive integer X, comprising:
converting the positive integer X into a binary number;
determining whether a modulo N is expressed by a product of 2 to the m^{th} power and a value obtained by adding or subtracting one to or from 2 to the n^{th} power;
calculating the positive integers m and n, if the modulo N is expressed by the product of 2 to the m^{th} power and the value obtained by adding or subtracting one to or from 2 to the n^{th} power; and
grouping the binary number of the positive integer X into bit units varying according to the positive integers m and n to perform operation on the binary number of the positive integer X.

2. The method of claim 1, wherein all bits of the binary number of the positive integer X consist of r (r is a positive integer) n-bit units and m least significant bits.

3. The method of claim 2, wherein the performing of the operation on the binary number of the positive integer X includes:
calculating a value of a modified n-bit unit obtained by adding an upper bit to each of the n-bit units;
calculating final n bits from the value of the modified n-bit unit using a multiplexer and an adder; and
adding the m least significant bits to the final n bits to generate a binary modulo operation value.

4. The method of claim 3, wherein the calculating of the final n bits includes:
outputting the value of the modified n-bit unit as a first bit unit value when the value of the modified n-bit unit is smaller than a value obtained by adding or subtracting one to or from 2 to the n^{th} power, and subtracting the value obtained by adding or subtracting one to or from 2 to the n^{th} power from the value of the modified n-bit unit and outputting the result value as the first bit unit value when the value of the modified n-bit unit is larger than the value obtained by adding or subtracting one to or from 2 to the n^{th} power; and
when the first bit unit is plural in number, adding the output first bit unit values to calculate a second bit unit.

5. The method of claim 4, wherein the calculating of the final n bits includes repeating the calculating of the final n bits until the second bit unit corresponds to the final n bits.

6. An apparatus for a modulo N operation, comprising:
a binary number converter configured to convert a positive integer X into a binary number;
a variable calculator configured to determine whether a modulo N is expressed by a product of 2 to the m^{th} power and a value obtained by adding or subtracting one to or from 2 to the n^{th} power and calculate the positive integers m and n, if the modulo N is expressed by the product of 2 to the m^{th} power and the value obtained by adding or subtracting one to or from 2 to the n^{th} power; and
a bit unit calculator configured to perform operation on the binary number of the positive integer X according to bit units varying according to the positive integers m and n.

7. The apparatus of claim 6, wherein all bits of the binary number of the positive integer X converted by the binary number converter consist of r (r is a positive integer) n-bit units and m least significant bits.

8. The apparatus of claim 7, wherein the bit unit calculator includes:
a modified n-bit unit calculator configured to calculate a value of a modified n-bit unit obtained by adding an upper bit to each of the n-bit units;
a final n-bit calculator configured to calculate final n bits from the value of the modified n-bit unit using a multiplexer and an adder; and
a bit combiner configured to add the m least significant bits to the final n bits calculated by the final n-bit calculator.

9. The apparatus of claim 8, wherein the final n-bit calculator includes:
a first bit unit calculator configured to output the value of the modified n-bit unit as a first bit unit value when the value of the modified n-bit unit is smaller than a value obtained by adding or subtracting one to or from 2 to the n^{th} power, and subtract the value obtained by adding or subtracting one to or from 2 to the n^{th} power from the value of the modified n-bit unit and is output the result value as the first bit unit value when the value of the modified n-bit unit is larger than the value obtained by adding or subtracting one to or from 2 to the n^{th} power; and
a second bit unit calculator configured to add, when the first bit unit is plural in number, the output first bit unit values to calculate a second bit unit.

10. The apparatus of claim 9, wherein the bit combiner repeats the calculation until the second bit unit corresponds to the final n bits.
